(19) United States
(12) Patent Application Publication
(10) Pub. No.: US 2018/0293830 A1
(43) Pub. Date: Oct. 11, 2018

(54) AUTHENTICATION APPARATUS AND METHOD

(71) Applicant: INNOVIA FILMS LIMITED, Wigton, Cumbria (GB)

(72) Inventor: Robert Laird STEWART, Wigton (GB)

(21) Appl. No.: 15/570,652

(22) PCT Filed: Jul. 12, 2016
(86) PCT No.: PCT/GB2016/052101

§ 371 Date: Oct. 30, 2017

(30) Foreign Application Priority Data
Jul. 13, 2015 (GB) 1512197.3

(51) Int. Cl. G07D 7/202; G07D 7/1205

(52) U.S. Cl. CPC G07D 7/205; B42D 25/29; G07D 2207/00; G07D 7/1205

(57) ABSTRACT

An authentication apparatus is operative to determine the authenticity of a polymer film, The authentication apparatus comprises an optically-based birefringence measuring apparatus and may be used to determine the authenticity of a banknote comprising a polymer film.

This application is a national stage application of International Patent Application No. PCT/GB2016/052101, filed on Jul. 12, 2016, which claims priority from Great Britain patent Application No. 1512197.3, filed on Jul. 13, 2015. The entirety of the aforementioned applications is incorporated herein by reference.

### FIELD

The present invention relates to an authentication apparatus and method, and particularly, but not exclusively, to an authentication apparatus for and method of authenticating a polymer film.

### BACKGROUND

Polymer films are increasingly being used as substrates in fields where security, authentication, identification and anti-counterfeiting are important. Polymer-based products in such areas include for example bank notes, important documents (e.g. ID materials such as for example passports and land title, share and educational certificates), films for packaging high-value goods for anti-counterfeiting purposes, and security cards.

One particularly useful application of this invention concerns the integration of authentication systems into banknote sorting machines.

The increasing use of polymeric film materials in the banknote industry may in part at least be ascribed to certain advantages exhibited by polymeric films over the more traditional paper-based materials as regards anti-counterfeiting measures. One property of such materials which is useful in that respect is birefringence, as has been described at length in our publications WO2009/133390, WO2012/032361, WO2014/060362, WO2014/181086, WO2014/181087, WO2014/181088, WO2014/181089 and WO2014/181090. Many of these documents contain detailed descriptions of various types of polymer films, their methods of manufacture, and of the property of birefringence as it pertains to such films, and methods of and uses for its measurement, and the contents of each of these documents is incorporated herein by reference.

In particular, WO2014/181086 describes an authentication apparatus operative to determine the authenticity of a polymer film, comprising an optically-based birefringence measuring arrangement operative to measure a first effect influenced by a birefringence characteristic of said film from a first angle comprising a non-normal angle to a plane of said film, and at least one of: a second angle; and a third angle; and wherein said apparatus is operative to: compare a value, or range of values, representative of said first effect as measured from said first angle with a value, or ranges of values representative of a specified first effect corresponding to a predetermined birefringence characteristic of an authentic polymer film for said first angle; compare a value, or range of values, representative of said first effect as measured from said at least one of said second and third angles with a value, or range of values representative of a specified first effect corresponding to a predetermined birefringence characteristic of an authentic polymer film for respective second and/or third angles; and output an authenticity signal indicative of authenticity or otherwise of said film based upon said comparisons.

WO2014/060362 describes an authentication apparatus operative to determine the authenticity of an item comprising a film substrate responsive to detection that a portion of said item located in a measuring region of said apparatus has a predetermined birefringence characteristic, said apparatus comprising: an item detection arrangement operative to determine if at least a portion of an item is located in a measuring region of said authentication apparatus; and an optically-based birefringence measuring apparatus, wherein said authentication apparatus is operative to compare a measured birefringence characteristic with a predetermined birefringence characteristic and to produce an authenticity signal indicative of authenticity or otherwise of said item based upon said comparison, said apparatus further comprising a control means operative to control output of said authenticity signal from said apparatus responsive to determination, by said item detection arrangement, of presence or otherwise of said at least a portion of said item in said measuring region.

The property of birefringence has proved to be useful as a reliable indicator of authenticity, and it could usefully become more widespread as an indicative tool, particularly if new techniques could be developed to improve the reliability and range of operation of such tools. It would be particularly desirable to back-integrate apparatus for its measurement or characterization into existing and established technologies pertaining to banknote sorting machines. To date, certain custom built, low volume and somewhat complex machines have been developed, but there is an ongoing need for simple, robust and reliable techniques that are compatible with established banknote sorting practices. There are also opportunities to adapt and improve birefringence characterization technologies for new products in the authentication field, which may range from single note detectors to large sorting devices.

### BRIEF DESCRIPTION OF DRAWINGS

One or more specific embodiments in accordance with aspects of the present invention will be described, by way of example only, and with reference to the following drawings.

FIG. 1 shows a schematic diagram of an authentication apparatus operating RGB (red/green/blue) channels in accordance with the invention;

FIG. 2 shows a schematic diagram of a sensor array chip.

FIG. 3 shows in graphical form a greyscale image of a birefringent material through crossed polarisers.

FIG. 4 shows integrated retardation graphs for red, blue and green sources.

### DETAILED DESCRIPTION

The present invention provides methods and apparatus for determining authenticity of a polymer film by exposing the film to at least two different light sources of different wavelength and determining authenticity with reference to the compared birefringence of the film at the different wavelengths.

According to an aspect of the present invention, there is provided an authentication apparatus operative to determine the authenticity of a polymer film, comprising an optically-based birefringence measuring apparatus operative to:
expose the film to a first light source of a first wavelength or range of wavelengths;
expose the film to a second light source of a second wavelength or range of wavelengths, the first wavelength or range of wavelengths being different from the second wavelength or range of wavelengths;
measure a first effect influenced by a birefringence characteristic of the film responsive to said first light source;
measure a second effect influenced by a birefringence characteristic of the film responsive to said second light source;
compare a value or range of values representative of a comparison between the first and second effects with a value or range of values representative of a comparison between a specified first effect and a specified second effect corresponding to a predetermined birefringence characteristic of an authentic polymer film responsive to the first and second light sources; and
output an authenticity signal indicative of authenticity or otherwise of the film based upon one or more of the comparisons.

In most prior art systems, birefringence is measured using equipment with a white-light light source and then integrating (essentially averaging) the intensity of light that is received at the detector. That is, measurements are integrated across a white spectrum. This has meant that measurements taken for stenter films could be quite similar to measurements taken for bubble process films.

Measurement of birefringence has been standardized using a 0 to 1 scale, where a value of 0 represents no birefringence (i.e. a pair of crossed polarisers with no item present). A value of 1 represents birefringence when an item having “half-wave” properties (around 275 nm retardation) is present. In the standardized (i.e. 0 to 1) birefringence measurement scale used with prior art detection systems, a BOPP bubble process film would usually give rise to a measurement reading of from about 0.0 to about 0.3 in the standardized birefringence measurement scale. However, measurement readings of about 0.4 to about 0.6 in the standardized birefringence measurement scale could commonly be seen for stenter films. The objective of the present invention is to expand the range and accuracy of authenticity determination beyond what has been achievable in prior art systems.

For example, the system disclosed in WO 2009/133390 comprises a detection system in which a film to be authenticated is positioned between the first and second polarisers. The light source of that system is operative to emit white-light. This white light which passes through the system comprises light not just of one wavelength, but of a whole range of wavelengths. Each wavelength in that range will interfere at the second polariser differently according to the relationship between it and its wavelength.

A white-light single-detector integrating system of the type disclosed in WO 2009/133390 effects a measurement at the detector end of the system which effectively is an integration of the transmission of all the light from a white light source into a single value. Because of this, it cannot resolve the color changes found at retardations higher than the first order. Therefore, some information is lost in measurements taken by a system of this type.

Consequently, this measurement technique returns similar values representative of birefringence for quite different films. The reasons for the transmission levels are quite different. A bubble film will have a near flat spectrum that will appear white to an observer's eye and a stenter film will transmit a specific color that will be a result of a loss of part of the visible spectrum. This loss of part of the visible spectrum is what decreases the integrated intensity.

Our publication WO2014/181086 takes some steps to allow for this by suggesting the incorporation of a wavelength filtering element operative to be located in a beam path of light travelling between the light source and the detector. The apparatus is operative to select different portions of the spectrum of the polarised transmitted light upon which to perform a detection measurement. It is suggested to use alternative modes of operation in which alternate white and colored light sources are used as alternate means of determining birefringence characteristics. It is recognized that it may be desirable to tune or filter the light source for a birefringence measurement to a particular wavelength, and recognizes the benefit of determining birefringence effects responsive to a second wavelength of light in the event that an inconclusive determination of authenticity results from the determination of birefringence effects responsive to a first wavelength of light. However, this publication fails to recognize the substantial benefit of providing multiple wavelength light sources and using the comparison between birefringence effects created by two or more of them as a means of determining authenticity.

Preferably the authentication apparatus of the invention is operative to expose the film simultaneously to the first and second light sources, and to determine authenticity based on the comparison between the first and second effects.

The measured effects may, in one embodiment of the invention, relate to or be the wavelength of the light transmitted and/or reflected from the film. For example, the measured effects may relate to or be the retardation of wavelength (compared to the original wavelength or range of wavelengths) of the light transmitted and/or reflected from the film.

Retardation of wavelength is considered herein to be an example of an effect influenced by a birefringence characteristic.

It may be desirable for the authentication apparatus of the invention to be operative to make additional comparisons to aid authenticity determination, for example to:
compare a value or range of values representative of the first effect with a value or range of values representative of a specified first effect corresponding to a predetermined birefringence characteristic of an authentic polymer film responsive to the first light source; and/or
compare a value, or range of values, representative of the second effect with a value or range of values representative of a specified second effect corresponding to a predetermined birefringence characteristic of an authentic polymer film responsive to the second light source.

The apparatus may additionally be operative to expose the film to any number of additional (e.g. third, fourth or fifth) light sources, each having wavelengths or wavelength ranges different from each other and different from each of the first and second wavelengths or wavelength ranges. In that case the apparatus may then be configured to measure for example a third effect influenced by a birefringence characteristic of the film responsive to a third light source, and to compare a value, or range of values, representative of a comparison between the third effect and either or both of the first and second effects with a value or range of values representative of a comparison between the specified third effect and either or both of the first and second effects corresponding to a predetermined birefringence characteristic of an authentic polymer film responsive to the first and third, or second and third, or first, second and third light sources.

It will be apparent that in the event of a third light source being present, the apparatus may further be operative to compare a value or range of values representative of the third effect with a value, or range of values representative of a specified third effect corresponding to a predetermined birefringence characteristic of an authentic polymer film responsive to the third light source.

It will further be understood that the apparatus may then be configured to measure for example an nth effect influenced by a birefringence characteristic of the film responsive to an nth light source, and to compare a value, or range of values, representative of a comparison between the nth effect and one or more of the (n-m)th effects (where m is any number between 1 and n-1) with a value or range of values representative of a comparison between the specified nth effect and one or more of the (n-m)th effects corresponding to a predetermined birefringence characteristic of an authentic polymer film responsive to the nth and (n-m)th light sources.

In these cases it will also be apparent that the apparatus may be operative to compare a value or range of values representative of the nth effect with a value, or range of values representative of a specified nth effect corresponding to a predetermined birefringence characteristic of an authentic polymer film responsive to the nth light source.

The first wavelength or wavelength range may comprise at least one wavelength in the range of from about 660±20 nm. The first wavelength or range of wavelengths may therefore correspond, in whole or in part, to visible light in the red region of the spectrum.

The second wavelength or wavelength range may comprise at least one wavelength in the range of from about 550±20 nm. The second wavelength or range of wavelengths may therefore correspond, in whole or in part, to visible light in the green region of the spectrum.

The third wavelength or wavelength range may comprise at least one wavelength in the range of from about 460±20 nm. The third wavelength or range of wavelengths may therefore correspond, in whole or in part, to visible light in the blue region of the spectrum.

The apparatus may be operative to differentiate between films made by a bubble process and films made by a different process.

The optically-based birefringence measuring apparatus may comprise in connection with the or each light source:
the light source located and operative to illuminate a first side of the film located in a measuring region of the apparatus with light having the wavelength or range of wavelengths; a first polariser located between the light source and the first side of the film so that at least a portion of light emitted by the light source passes therethrough; a detector located on a second side of the film, and operative to receive light from the light source transmitted through and/or reflected from the film and transmitted and/or reflected from the second side of the film at a retarded wavelength or range of wavelengths; a second polariser located between the second side of the film and the detector so that at least a portion of light transmitted through the film passes therethrough, wherein the detector is operative to output a signal representative of the birefringence effect as measured based upon light transmitted and/or reflected from the second side of the film at the retarded wavelength or range of wavelengths;

The first and/or second polarisers may each comprise separate polarisers for each light source, or may be the same polariser for any two or more of the light sources.

The detector may comprise separate detectors for each light source, or may be the same detector for any two or more of the light sources.

It is a necessary aspect of the invention that the authentication apparatus is operative to make a comparison between birefringence effects responsive to light of at least two different wavelengths. However, it will be apparent that there are a number of ways in which to configure the apparatus to allow that comparison. In a first aspect, the apparatus may comprise separate light sources and unfiltered detectors, such as photodiode arrays or CIS detectors for example. In a second aspect a one or more white light sources may be used, with suitable wavelength filters either on the detector(s) and/or on the light source(s). It is also contemplated as a third aspect, and in the case in which three different wavelengths of light (red, green and blue) are used, to make use of industry standard RGB chips (photodiodes with associated wavelength filters) as the light source. It will be apparent that the first and second aspects permit variation of the number and nature of wavelengths/colors which may be compared. The third aspect limits the comparison to RGB channels, but may well be attractive from a cost effectiveness perspective.

The apparatus may further comprise one or more nth detectors located on a second side of the film, and operative to receive light from the nth light source transmitted through the film and transmitted and/or reflected from the second side of the film at the retarded nth wavelength or range of wavelengths; wherein the nth detector is operative to output a signal representative of the nth effect as measured based upon light transmitted and/or reflected from the second side of the film at the retarded nth wavelength or range of wavelengths.

The signal output by the or each detector may be proportional to an intensity of transmitted light received.

The nth detector may be operative to communicate the output signal to a processor which is operative to compare a value of the output signal representative of the nth effect as measured from the nth wavelength or range of wavelengths with the value or range of values representative of a specified nth effect corresponding to a predetermined birefringence characteristic of an authentic polymer film for the nth wavelength or range of wavelengths. The value or range of values may comprise at least one expected nth detector output signal value representative of light transmitted and/or reflected from the second side of the film at the nth wavelength or range of wavelengths and received by the nth detector if an authentic film is located in the measuring region.

Any detector may be operative to output an nth signal representative of an nth effect as measured and to output an (n-m)th signal representative of the (n-m)th effect as measured. The or each output signal may be proportional to the intensity of transmitted light received.

The nth detector may be operative to communicate the nth and (n-m)th output signals to a processor which is operative to compare a value of the nth output signal with a value, or range of values, representative of the specified nth effect; and compare a value of the (n-m)th output signal with a value, or range of values, representative of the specified (n-m)th effect corresponding to a predetermined film transmissivity and/or reflectivity.

The value or range of values may comprise at least one expected nth output signal value representative of light transmitted and/or reflected from the second side of the film and received by the nth detector if an authentic film is located in the measuring region.

The optically-based birefringence measuring apparatus may therefore be operative to measure a nth effect influenced by the birefringence characteristic of the film over the nth wavelength or range of wavelengths and at least one of the (n-m)th wavelength or range of wavelengths, and wherein the apparatus is operative to: compare a value, or range of values, representative of the nth effect as measured at the nth wavelength or range of wavelengths and at least one of the (n-m)th wavelength or range of wavelengths with a respective value, or range of values, representative of a specified nth effect corresponding to a predetermined birefringence characteristic of an authentic polymer film for the nth wavelength or range of wavelengths and respective (n-m)th wavelength or range of wavelengths; and output an authenticity signal indicative of authenticity or otherwise of the film based upon the comparison.

The or each nth detector may be configured for selective response to any one or more of the nth and (n-m)th wavelengths or wavelength ranges.

The apparatus may be operative to: compare the value, or range of values, representative of the nth effect as measured at the nth wavelength or range of wavelengths and at least one of the (n-m)th wavelength or range of wavelengths with the value, or range of values, representative of a specified nth effect corresponding to a predetermined birefringence characteristic of a polymer film of a first genuine type at a respective nth and (n-m)th wavelength or range of wavelengths; and output a classification signal indicative of the film comprising a first genuine type or otherwise based upon the comparison.

The apparatus may further comprise an optically-based birefringence imaging apparatus for imaging a birefringence pattern of the film at the nth wavelength or range of wavelengths and at least one of the (n-m)th wavelength or range of wavelengths, and wherein the apparatus is operative to: compare an image of the birefringence pattern with a respective image representative of a predetermined birefringence pattern of an authentic polymer film at the respective nth and (n-m)th first wavelength or range of wavelengths; and output an authenticity signal indicative of authenticity or otherwise of the film based upon the comparison.

The optically-based birefringence imaging apparatus may therefore comprise a light source located, and operative, to illuminate a first side of the film located in a measuring region of the apparatus with light; a first polariser located between the first light source and the first side of the film so that at least a portion of light emitted by the first light source passes therethrough; an imaging device located on a second side of the film, and operative to receive light from the light source transmitted through the film and transmitted and/or reflected from the second side of the film; a second polariser located between the second side of the film and the imaging device so that at least a portion of light transmitted through the film passes therethrough, wherein the imaging device is operative to output data representative of an imaged birefringence pattern based upon light transmitted and/or reflected from the second side of the film and received at the imaging device.

The imaging device may be operative to output the data representative of an imaged birefringence pattern to a processor which is operative to compare the output data with a data-set representative of a predetermined birefringence pattern.

Optionally, at least one of: the light source; the first polariser; and the second polariser may be common with that/those of the optically-based birefringence measuring apparatus and/or of the optically-based measuring apparatus.

The imaging device may comprise a photosensitive array.

The authentication apparatus may be a contact image sensing apparatus modified to incorporate means effective to operate the authenticity determination as described above. Modification may comprise the addition of one or more polarisers to a contact image sensing apparatus, for example by replacing a glass contact surface of such an apparatus with a glass polariser, or by inserting one or more (preferably thin) polarisers underneath the glass surface of such an apparatus.

The apparatus may be configured to receive an item comprising a polymer film forming at least a portion of a substrate of the item.

According to another aspect of the present invention, there is provided a banknote authentication apparatus comprising an apparatus including any one or more of the features described above, wherein the apparatus is operative to determine the authenticity of a banknote comprising a polymer film forming at least a portion of a substrate of the banknote.

The apparatus comprising any one or more of the features as described above may be used to determine the authenticity of a polymer film.

According to another aspect of the present invention, there is provided a method for determining the authenticity of a polymer film, comprising:
providing an optically-based birefringence measuring apparatus as hereinbefore described:
   exposing the film in the apparatus to a first light source of a first wavelength or range of wavelengths;
   exposing the film in the apparatus to a second light source of a second wavelength or range of wavelengths, the first wavelength or range of wavelengths being different from the second wavelength or range of wavelengths;
   measuring a first effect influenced by a birefringence characteristic of the film responsive to said first light source;
   measuring a second effect influenced by a birefringence characteristic of the film responsive to said second light source;
   comparing a value or range of values representative of a comparison between the first and second effects with a value or range of values representative of a comparison between a specified first effect and a specified second effect corresponding to a predetermined birefringence characteristic of an authentic polymer film responsive to the first and second light sources; and
   outputting an authenticity signal indicative of authenticity or otherwise of the film based upon one or more of the comparisons.

Other aspects of the method of the invention will be apparent from the foregoing description of the apparatus. Each of the apparatus features as hereinbefore described are applicable to the method of the invention which is intended to describe a method for determining the authenticity of a polymer film by using the aforesaid apparatus.

According to another aspect of the present invention, there is provided a computer program comprising computer program elements operative in a computer processor to implement one or more aspects of an authentication apparatus or method as described above and hereinafter.

According to another aspect of the present invention, there is provided a computer readable medium carrying a computer program as described above.

Also provided in accordance with the invention is a method for improving the accuracy or sensitivity of the aforesaid apparatus by processing data obtained in relation to the measured first and/or second effects through machine intelligence such as a neural network in a processing part of the authentication apparatus. Accurate identification of the effect influenced by birefringence (e.g. retardation) may depend on other factors such as the variability of colour within the image, the reliability of the sensitivity data and the proximity of some signals to others at some retardation values. Neural networks can be used to improve these results. Artificial neural networks have been used for several years for applications such as image recognition. For example, an artificial neuron with a given input signal, a given threshold and firing a given output may be stimulated via an input signal which, if it is greater than the neuron's activation threshold, will cause the neuron to fire, i.e. outputting a weighted output signal.

When neurons are arranged in several layers they produce what is known as a neural network; every neural network has an input layer into which a normalised series of signals are inputted—and an output layer—each neuron of which is an output for the system. A simple two layered structure is only suitable for linear relationships; more complex interactions require one or more hidden layers between the input and output layer.

Every neuron's output in the input layer is connected to the inputs of every neuron in the hidden or output layer; if a neuron is stimulated above its threshold, it will fire a weighted output into all the neurons of the next layer which will fire if the combined output from all the neurons of previous layer exceed each of their weighted threshold values. Such a neural network may be used to identify retardation values from RGB input values.

In FIG. 1 is shown an authentication apparatus operative to measure birefringence characteristics of an item 108 (e.g. a banknote). In particular, the authentication apparatus is operative to measure birefringence of a portion of the item 108 located in a measuring region of the authentication apparatus.

Processor 104 (optionally a microcontroller) is operative to control the birefringence measuring apparatus 102. An input of the birefringence measuring apparatus 102 is coupled to the processor 104 and is controllable by the processor 104. An output of the birefringence measuring apparatus 102 is coupled to the processor 104. The processor 104 is operative to determine whether or not the item 108 in the authentication apparatus is authentic based upon an output signal received from the birefringence measuring apparatus 102. An outcome of such determination is indicated (e.g. to an apparatus operator) via alert system 106. The alert system 106 is coupled to the processor 104 and is operative to output an indication of authenticity or otherwise based upon a signal received from said processor 104.

The birefringence measuring apparatus 102 comprises a three light sources 110a, 110b and 110c (optionally LEDs) operative respectively to produce light in the Red, Green and Blue regions of the visible spectrum, a first polariser 112, a second polariser 114, and three detectors 116a, 116b and 116c (optionally photodiodes). The polarisers 112, 114 are spaced apart and oriented so as to be substantially parallel. The region between the polarisers 112, 114 defines a measuring region.

Detectors 116 may be operated in two different basic configurations, transmissive, in which the light source illuminates the film from the rear and the detector measures the transmitted light, and transmissive/reflective in which light reflected from either or both surfaces of the film is detected. In either case polarisers 112, 114 may be crossed or parallel.

Detectors 116 are operative to detect a birefringence effect (eg retardation of the transmitted and/or reflected light). However they may also capture images of the measured film, or secondary detectors may be arranged to do so. It will be apparent that in a modified CIS unit image capture detectors will be present. Transmissive imaging may result in print details of the film (eg banknote) being lost, whereas a transmission-reflection system allows the transmissive light from the rear of the film to be added to the reflective image normally captured by the CIS unit. A system such as this can be double sided (if the CIS units are slightly offset, then the light from one will shine onto the sensors from the other) and crossed or parallel.

The elements of the birefringence measuring apparatus 102 are arranged such that the light sources 110 and first polariser 112 are located on a first side of the measuring region of the birefringence measuring apparatus 102, and the first detectors 116 and the second polariser 114 are located on a second side of the measuring region (i.e. opposite the first light sources 110 and first polariser 112).

Light sources 110 are operative to illuminate the first polariser 112 with light (denoted by arrows ILa, ILb and ILc in the figure). This illuminating light IL is polarised by the first polariser 112 as it passes therethrough and continues as polarised illuminating light (denoted by arrows PILa, PILb and PILc in the figure) to irradiate a portion of the item 108 located in the measuring region. A portion of the polarised illuminating light which is transmitted through a portion of the item 108 (denoted by arrows TLa, TLb and TLc) continues toward second polariser 114. This transmitted light TL is polarised by second polariser 114 as it passes therethrough, and continues as polarised transmitted light (denoted by arrows PTLa1, PTLa2, PTLa3; PTLb1, PTLb2, PTLb3; PTLc1, PTLc2, PTLc3) towards detectors 116a, 116b and 116c. Each detector 116(a,b or c) is located, oriented and operative to receive the polarised transmitted light PTL(a, b or c)1, PTL(a, b or c)2 or PTL(a, b or c)3.

It will be understood from the foregoing that the illustrated embodiment represents a three-component light source in the RGB regions of the spectrum, but that in principle an n-component light source may be used.

The measuring region generally defines a plane between the spaced polarisers 112, 114. The first polariser 112 is spaced from this first plane and is located in a second plane on a first “upstream” side of the measuring region. The second plane is substantially parallel to the first plane. Similarly, the second polariser 114 is spaced from the first plane and is located in a third plane on a second “downstream” side of the measuring region. It is located opposite the first polariser 112, and the third plane is substantially parallel to the first and second planes. The apparatus of transmission orientations of the first and second polarisers 112, 114 is such that they comprise crossed polarisers. That is, the first polariser 112 is arranged such that a transmission orientation thereof is about +45° to a transmission orientation of the portion of the item 108 located in the measuring region. The second polariser 114 is arranged such that a transmission orientation thereof is about −45° to the transmission orientation of the portion of the item 108 located in the measuring region. Alternatively, the transmission orientation of the first polariser 112 may be such that it is about −45° to a transmission orientation of the portion of the item 108 located in the measuring region and the transmission orientation of the second polariser 114 may be such that it is about +45° to the transmission orientation of the portion of the item 108 located in the measuring region.

Thus, in the illustrated apparatus, the illuminating light ILa, ILb, ILc emitted by light sources 110a, 110b, 110c will be polarised by the first polariser 112, and will irradiate the portion of the item 108 located in the measuring region as polarised illuminating light PILa, PILb, PILc. This polarised illuminating light passes through the item 108, and continues as transmitted light TLa, TLb, TLc to the second polariser 114 (i.e. crossed polariser). The transmitted light passes through second polariser 114 and continues as polarised transmitted light PTL(a, b or c)1, PTL(a, b or c)2, or PTL(a, b or c)3 for reception by the detectors 116. The detectors 116, responsive to detection of polarised transmitted light PTL(a, b or c) 1 or PTL(a, b or c)2 or PTL(a, b or c)3 incident thereon, output a signal proportional to the intensity of polarised transmitted light PTL(a, b or c)1 or PTL(a, b or c)2 or PTL(a, b or c)3 respectively to the processor 104.

In the illustrated apparatus, the detectors 116 are operative to measure received polarised transmitted light transmitted and/or reflected from the second polariser 114 at three different wavelength or range of wavelengths, namely: at a first retarded wavelength or range of wavelengths retarded from light source 110a; at a second retarded wavelength or range of wavelengths retarded from light source 110b; and at a third retarded wavelength or range of wavelengths retarded from light source 110c. Thus, the detectors 116 will output three measurement signals to the processor 104.

(Detectors 116a, 116b and 116c may be combined into a single detector for this purpose. Light sources 110a, 110b and 110c may all emanate from a single source, provided that three different wavelengths or wavelength ranges can be emitted simultaneously or substantially so.)

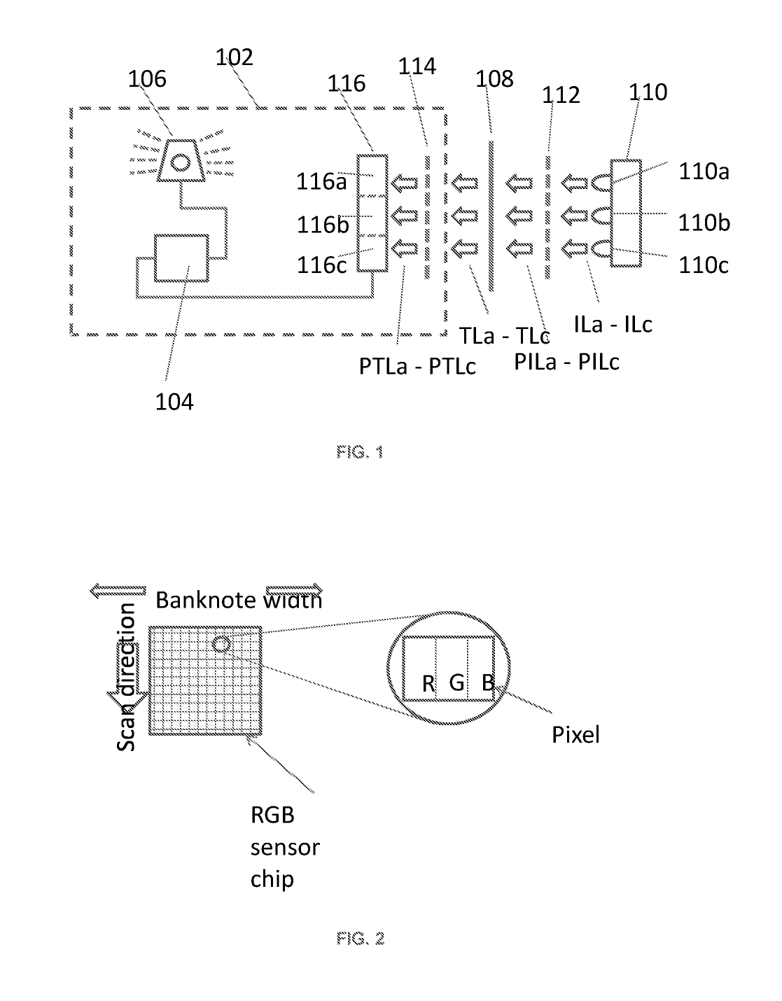

The or each detector 116 may be provided in the form of a sensor array chip of the type schematically shown in FIG. 2. This type of chip, commonly found in photographic equipment, permits multiple readings in the RGB channels to be taken simultaneously and may also be operative to filter out spikes and then average to reduce noise. This chip is composed of a 2D array of pixels, each comprising three sub-pixels: red, green and blue. The sub-pixels themselves are composed of a standard photodiode/photoresistor/CMOS/CCD/HMOS/NMOS detector located behind a colored filter. The colored filter may be a separate film or may be deposited directly (e.g. by vacuum deposition) onto the photo-detector.

In this application, one dimension is used to measure the width of the note and the other to take signals in the transport direction of the note. Each pixel forms its own transport direction profile of the birefringence of the passing “slice” of the note. Using a 2D array permits collection of multiple points for each part of the machine direction profile, improving data collection (and the capacity of the apparatus to average that data), the speed and timing of measurement, and also provides means for mapping the movement of the window through the machine, and for reliability testing (i.e. using the timing measurement to match up results from each sensor to take measurements of specific parts of the window).

The processor 104, upon receiving the three output measurement signals from the detectors 116, is operative to: compare a value of a first of the received signals with a first set of pre-defined values stored in a database (not shown); compare a value of a second of the received signals with a second set of pre-defined values stored in the database; and compare a value of a third of the received signals with a third set of pre-defined values stored in the database. These pre-defined values correspond to expected polarised transmitted light values when an authentic item (e.g. an authentic film) is located in the measuring region.

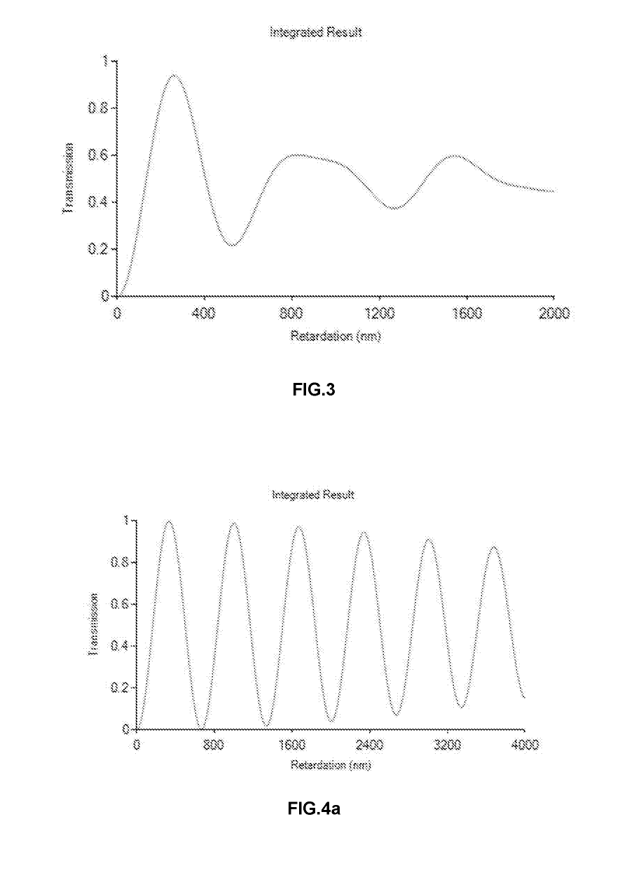

FIG. 3 illustrates prior art detection of retardation using greyscale images. Values of less than 0.3 of the maximum intensity cannot occur for retardation values greater than 275 nm (cf those for a typical stenter manufactured film are 800 nm+). If 0.3 is set as the production specification for an authentic polymeric film greyscale analysis authenticates this result and as such have found utility in small devices such as the handheld and desktop authentication units.

RGB channels can have their integrated retardation graphs calculated in the same way (except that there no longer exists a flat source for original Intensity (Iₒ)). Intensity, I, at any wavelength can be calculated by equation (1):

$${I}_{λ} = {I}_{o} {sin [ π + \frac{kR}{λ} ]}^{2} \qquad ( 1 )$$

Where λ, is the wavelength, k is the stretch coefficient (k=1+kₒλ, where kₒ is a constant), R is the retardation (nm) and I_{c} is the intensity of the original light source. Addition of all the wavelengths together in a light source produces an integrated value, which describes the behaviour of the birefringent material to a broadband light source. FIG. 2 shows the integrated result for a white light source (400-700 nm); this simulates the readings expected from a non-discriminating detector such as a photodiode that detects only intensity.

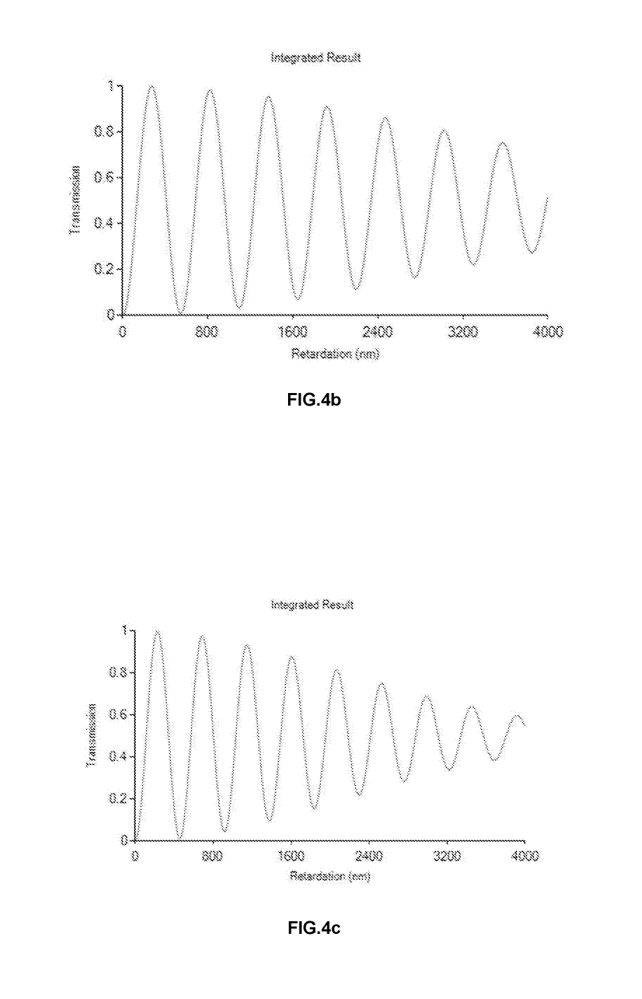

FIG. 4(a)-(c) shows this for typical red (660 nm±20 nm, green (550 nm±20 nm) and blue (460 nm ±) light sources.

Comparing FIGS. 4(a)-(c), the three traces differ in terms of the frequency of the sinusoidal and also the evolution of frequency with retardation. The three graphs correspond with one another for only the first 275 nm (which corresponds to the large first peak on FIG. 2 and is the value of a half wave retarder). Processor 104 receives three output measurement signals from detectors 116, which may be characterized as RΔG, RΔB and BΔG—that is to say the difference in retardation as between red, blue and green light from the respective light sources. Processor 104 calculates an authenticity result based on the algorithm:
If RΔG and RΔB and BΔG<threshold then
retardation<=275 nm
retardation=mean(RGB)−min/(max−min)
Else:
Retardation>275 nm

If the differences between red and green, red and blue and, blue and green are less than a set threshold, retardation is always less than 275 nm and can be calculated by taking a mean of the RGB signal, subtracting the min (empty detector) and dividing the result by the max (1/2 wave value) minus min (empty detector).

Compared with prior art systems this increases the range of birefringence discrimination to 275 nm from the selected product specification value at 0.3 intensity, which is 82.5 nm, thereby more than tripling the measurement scale, allowing verification of a wider range of substrates.

More sophisticated processing algorithms may allow the technique to be extended to substrates exhibiting retardation values of over 275 nm. For example, comparison of the measured value for the red, green and blue channels may be made with expected values, and a calculation made to determine at which retardation they are least different.

In determining expected values, a 2D array of constants may be pre-calculated using equation (2):

Comparison Array [pixel, r]=∫ₚᵢₓₑₗ₌₀^{pixel=255}∫ᵣ₌₀^{r=4000}[\sqrt{(pixel−Icolour)²}δpixel δr (2)

For each retardation level and each of the 0-255 pixel values, the difference between a hypothetical pixel value and the intensity expected for the colour channel (Icolour) may be calculated using a root-mean-square method. Calculated for each channel, where pixel is a pixel level (0-255), Icolour is an expected value for the channel at a retardation, r. Three 2D arrays of information may be stored in the processor of the apparatus for comparison.

A second algorithm for retardation values greater than 275 nm may be formulated as follows:
Result=16000000
For r=0 to 4000
Test=RedArray[Red,r]+GreenArray[Green,r]+BlueArray[Blue,r]
If Test<Result
Result=Test
Next r

Where Result is the answer, r is the retardation, RedArray, GreenArray and BlueArray are the ComparisonArrays for each channel, Red, Green and Blue are the measured results and Test is the sum of the differences between the measured results and the stored channels.

This algorithm may be operated as a single loop to compare the total value of the differences between the measured RGB channels and their stored values. The difference for each channel is found by looking at each stored array, the address within the array is given by the coordinates of the retardation (r) and the measured pixel value for each channel. The Test value is then compared against a Result value that may initially be set at a high level; if the Test value is less than this, then Result is replaced by the Test value. So in real time the algorithm cycles through the retardations, sums them and tests them against a minimum value.

The processor 104, after conducting such comparisons, is operative to instruct the alert system 106 to indicate that the film/item is authentic or non-authentic. If the result of the comparison is positive (i.e. the film is authentic), the processor is operative to send a signal to the alert system 106 containing an instruction to issue an indication that the film/item is authentic. Otherwise, the processor is operative to send a signal to the alert system 106 containing an instruction to issue an indication that the film/item is non-authentic.

1. An authentication apparatus operative to determine the authenticity of a polymer film, comprising an optically-based birefringence measuring apparatus comprising:
means to expose the film to a first light source of a first wavelength or range of wavelengths;
means to expose the film to a second light source of a second wavelength or range of wavelengths, the first wavelength or range of wavelengths being different from the second wavelength or range of wavelengths;
means to measure a first effect influenced by a birefringence characteristic of the film responsive to said first light source and to produce a first measured effect;
means to measure a second effect influenced by a birefringence characteristic of the film responsive to said second light source and to produce a second measured effect;
means to compare a value or range of values representative of a comparison between the first and second measured effects with a value or range of values representative of a comparison between a specified first effect and a specified second effect corresponding to a predetermined birefringence characteristic of an authentic polymer film responsive to the first and second light sources; and
means to output an authenticity signal indicative of authenticity or otherwise of the film based upon one or more of the comparisons.

2. The apparatus according to claim 1, operative to expose the film simultaneously to the first and second light sources, and to determine authenticity based on the comparison between the first and second effects.

3. The apparatus according to claim 1, wherein the measured effects relate to or are the wavelength of the light transmitted and/or reflected from the film.

4. The apparatus according to claim 3, wherein the first and second measured effects relate to or are the retardation of wavelength (compared to the original wavelength or range of wavelengths) of the light transmitted and/or reflected from the film.

5. The apparatus according to claim 1, operative to:
compare a value or range of values representative of the first effect with a value or range of values representative of a specified first effect corresponding to a predetermined birefringence characteristic of an authentic polymer film responsive to the first light source; and/or compare a value, or range of values, representative of the second effect with a value or range of values representative of a specified second effect corresponding to a predetermined birefringence characteristic of an authentic polymer film responsive to the second light source.

6. The apparatus according to claim 1, operative to expose the film to any number of additional light sources, each having wavelengths or wavelength ranges different from each other and different from each of the first and second wavelengths or wavelength ranges.

7. The apparatus according to claim 6, configured to measure a third effect influenced by a birefringence characteristic of the film responsive to a third light source, and to compare a value, or range of values, representative of a comparison between the third effect and either or both of the first and second effects with a value or range of values representative of a comparison between the specified third effect and either or both of the first and second effects corresponding to a predetermined birefringence characteristic of an authentic polymer film responsive to the first and third, or second and third, or first, second and third light sources.

8. Apparatus The apparatus according to claim 7, operative to compare a value or range of values representative of the third effect with a value, or range of values representative of a specified third effect corresponding to a predetermined birefringence characteristic of an authentic polymer film responsive to the third light source.

9. The apparatus according to claim 6, configured to measure an nth effect influenced by a birefringence characteristic of the film responsive to an nth light source, and to compare a value, or range of values, representative of a comparison between the nth effect and one or more of the (n-m)th effects (where m is any number between 1 and n-1) with a value or range of values representative of a comparison between the specified nth effect and one or more of the (n-m)th effects corresponding to a predetermined birefringence characteristic of an authentic polymer film responsive to the nth and (n-m)th light sources.

10. The apparatus according to claim 9, operative to compare a value or range of values representative of the nth effect with a value, or range of values representative of a specified nth effect corresponding to a predetermined birefringence characteristic of an authentic polymer film responsive to the nth light source.

11. The apparatus according to claim 9, operative to measure a nth effect influenced by the birefringence characteristic of the film over the nth wavelength or range of wavelengths and at least one of the (n-m)th wavelength or range of wavelengths, and wherein the apparatus is operative to: compare a value, or range of values, representative of the nth effect as measured at the nth wavelength or range of wavelengths and at least one of the (n-m)th wavelength or range of wavelengths with a respective value, or range of values, representative of a specified nth effect corresponding to a predetermined birefringence characteristic of an authentic polymer film for the nth wavelength or range of wavelengths and respective (n-m)th wavelength or range of wavelengths; and output an authenticity signal indicative of authenticity or otherwise of the film based upon the comparison.

12. The apparatus according to claim 9, operative to compare the value, or range of values, representative of the nth effect as measured at the nth wavelength or range of wavelengths and at least one of the (n-m)th wavelength or range of wavelengths with the value, or range of values, representative of a specified nth effect corresponding to a predetermined birefringence characteristic of a polymer film of a first genuine type at a respective nth and (n-m)th wavelength or range of wavelengths; and output a classification signal indicative of the film comprising a first genuine type or otherwise based upon the comparison.

13. The apparatus according to claim 9, further comprising an optically-based birefringence imaging apparatus for imaging a birefringence pattern of the film at the nth wavelength or range of wavelengths and at least one of the (n-m)th wavelength or range of wavelengths, and wherein the apparatus is operative to: compare an image of the birefringence pattern with a respective image representative of a predetermined birefringence pattern of an authentic polymer film at the respective nth and (n-m)th first wavelength or range of wavelengths; and output an authenticity signal indicative of authenticity or otherwise of the film based upon the comparison.

14. The apparatus according to claim 13, comprising a light source located, and operative, to illuminate a first side of the film located in a measuring region of the apparatus with light; a first polariser located between the first light source and the first side of the film so that at least a portion of light emitted by the first light source passes therethrough; an imaging device located on a second side of the film, and operative to receive light from the light source transmitted through the film and transmitted and/or reflected from the second side of the film; a second polariser located between the second side of the film and the imaging device so that at least a portion of light transmitted through the film passes therethrough, wherein the imaging device is operative to output data representative of an imaged birefringence pattern based upon light transmitted and/or reflected from the second side of the film and received at the imaging device.

15. The apparatus according to claim 1, wherein the apparatus is a contact image sensing apparatus modified to incorporate one or more polarisers.

16. The apparatus according to claim 1, wherein the apparatus is configured to comprise machine intelligence for assisting comparison of the authenticity signal indicative of authenticity or otherwise of the film.

17. A banknote authentication apparatus comprising the apparatus according to claim 1, wherein the banknote authentication apparatus is operative to determine the authenticity of a banknote comprising a polymer film forming at least a portion of a substrate of the banknote.

18. (canceled)

19. A method for determining the authenticity of a polymer film, comprising:
providing an optically-based birefringence measuring apparatus:
exposing the film in the apparatus to a first light source of a first wavelength or range of wavelengths;
exposing the film in the apparatus to a second light source of a second wavelength or range of wavelengths, the first wavelength or range of wavelengths being different from the second wavelength or range of wavelengths;
measuring a first effect influenced by a birefringence characteristic of the film responsive to said first light source;
measuring a second effect influenced by a birefringence characteristic of the film responsive to said second light source;
comparing a value or range of values representative of a comparison between the first and second effects with a value or range of values representative of a comparison between a specified first effect and a specified second effect corresponding to a predetermined birefringence characteristic of an authentic polymer film responsive to the first and second light sources; and
outputting an authenticity signal indicative of authenticity or otherwise of the film based upon one or more of the comparisons.

20. The apparatus according to claim 16, wherein the apparatus is configured to comprise a neural network.
